(19) United States
(12) Patent Application Publication
(10) Pub. No.: US 2024/0161091 A1
(43) Pub. Date: May 16, 2024

(54) Remote Integrated Mobile Wallet & Terminal System Facilitating Payments

(71) Applicant: Pace Software, Inc., Omaha, NE (US)

(72) Inventor: David Leppek, Omaha, NE (US)

(73) Assignee: Pace Software, Inc., Omaha, NE (US)

(21) Appl. No.: 17/987,612

(22) Filed: Nov. 15, 2022

Related U.S. Application Data
(60) Provisional application No. 63/280,076, filed on Nov. 16, 2021.

(51) Int. Cl. G06Q 20/36; G06Q 20/32; G06Q 20/40

(52) U.S. Cl. CPC G06Q 20/3674; G06Q 20/325; G06Q 20/40

(57) ABSTRACT

Disclosed is a remote integrated mobile wallet and terminal system facilitating payments which includes without limitation a mobile access device which includes software comprised of a digital wallet portion configured to store tokenized credit card information; and a merchant terminal portion comprised of transaction completion processing and transaction receipt processing; and further wherein the digital wallet portion and further wherein the use of the combination of the digital wallet portion and the merchant terminal portion interacting with the vendor system, cause resulting transactions to be classified as card-present transactions.

### CROSS REFERENCE TO RELATED APPLICATION

This application claims priority to and the benefit of U.S. Provisional Patent Application Ser. No. 63/280,076 filed Nov. 16, 2021, entitled Remote Integrated Mobile Wallet & Terminal System Facilitating Payments, the entirety of which is incorporated by reference herein.

### TECHNICAL FIELD

This invention pertains to a system providing a combined digital wallet and a merchant terminal for use in payment related systems and methods.

### BACKGROUND OF THE INVENTION

Recent regulatory changes have, for the first time, not disallowed merchant terminal software to be installed and certified compliant on a commercial off-the-shelf device, such as a smart phone or tablet. A common configuration in traditional retail point-of-sale solutions is that of a semi-integrated terminal with the cash-register for a more secure check-out process. Software wallets can safely contain tokenized credit cards for the consumers convenience.

The payments ecosystem, especially in the United States, is often divided into card-present and card-not-present transactions, where certain data passed in the transaction largely designates this distinction. The two transaction types are both priced differently and governed differently as it pertains to consumers dispute rights. Card-present transactions contain track-data, EMV chip-data, and secure data that is nearly impossible to fabricate and against card-brand rules to store.

In card-present transactions, generally by agreement the user or consumer, in approving this transaction via a remotely integrated commercial off the shelf device (such as a smart phone or tablet), is taking much more legal responsibility for aspects of the transaction, one example of which is the user taking full responsibility for that transaction and waiving certain dispute rights afforded them normally by the card-brand networks rules and regulations.

Card-not-present transactions have their own group of specialized data meant to mitigate the risk of a transaction but are still treated as less secure and often scrutinized by merchants, processors, and third parties in an effort to minimize fraud losses. For this reason, card-not-present transactions are much more expensive for a merchant to accept.

Consumers who frequent desired merchant locations, either physically or their website storefront, will often opt to save a card-on-file for the convenience of a quicker check-out process. These accounts on file are generally considered card-not-present transactions, even though in a vast majority of the cases the cardholder or consumer is actively participating in the check-out process.

Even in consumer-present retail and restaurant environments, there is a need for a consumer to access a payment method more easily so long as their payment information is stored safely and can conveniently provide it to their merchant without fumbling with a physical wallet and cards, or even a mobile wallet (or also referred to as a digital wallet) and the merchant's physical terminal. By combining the two in a single software solution on the consumers device, the entire exchange can take place with a simple acknowledgement.

Recurring transactions are charged on a regular schedule, per the terms of the merchant's contract with the cardholder, and often go un-noticed and billed even when the service is no longer desired. A consumer-acknowledged transaction would assure confirmation that the on-going service is still required and is therefore more secure.

Traditional Configuration Originally merchant point-of-sale solutions were considered fully integrated, which meant that the sensitive card-data would often be captured by the device and stored within the memory or database of that system. With card-brand regulatory changes, rules were established to safeguard the handling of such sensitive data. Regular audits were required to assure that this sensitive data was handled correctly. To minimize the scope of such audits, point-of-sale manufacturers transitioned to a semi-integrated configuration in which case the point-of-sale would pass a transaction identification number and a dollar amount to a secure terminal, and then the terminal would handle all sensitive card-data. This left the point-of-sale out-of-scope for a more stringent audit and made only the terminal provider undergo such exercises.

The terminal would connect to the point-of-sale via one of several methods. An RS-232 cable configuration was often difficult to configure and required advanced knowledge of computer systems. USB cables were easier to install but were restricted to select computers and varied lengths. Internet Protocol or ethernet configurations became much more standard and took advantage of existing local networks. Bluetooth or other wireless solutions were also used but more sparingly and usually in specific environments where it was required to facilitate communication with the merchant.

The point-of-sale cash-register would calculate the total amount of the sale and then communicate to the terminal. The terminal would spring to life, prompting the consumer the amount of the transaction, and then the consumer would produce their payment method to the terminal. The terminal would send the payment information securely to the processor for authorization, and then respond to the point-of-sale with the approval, and receipt information. The terminal would never share the sensitive data with the point-of-sale.

If the consumer used a software wallet and produced a tokenized card to the terminal, it was largely indistinguishable to the terminal and processed as if it was a traditional payment method.

Sensitive card data audits are governed by the Payment Card Industry Security Standard Council (PCI-SSC) and include the Payment Card Industry Data Security Standard (PCI-DSS), the Payment Application Data Security Standard (PA-DSS), the Point-to-Point Encryption Standard (P2PE), Tokenization Service Provider (TSP), and most recently the Contactless Payments on Commercial Off The Shelf devices (CPoCOTS).

The technical specifications of all such certifications are standardized and governed by EMV Co, a private company owned collectively by several of the major card-brands. An EMV Payment Token is a surrogate value that replaces a primary account number (PAN) in the payment ecosystem. It is used as part of the payment chain and, when submitted in a transaction to the payment system, would cause a payment to occur. One PAN may have multiple EMV Payment Tokens associated with it depending on the usage scenario. Payment tokens are generally restricted to specific domains. For example, a payment token may be usable only within the e-commerce acceptance channel at a specific merchant. They can be updated for a variety of reasons, such as in the event of a lost or stolen device or other lifecycle events.

Embodiments of the invention described herein are compliant with the CPoC technical requirements, and the subsequent certification procedures. CPoC is the acronym for Contactless Payments on Commercial off-the-shelf devices. This, combined with earlier programs such as the SPoC program, illustrates the beginning of a new acceptance trend, i.e. allowing standard mobile devices to become secure and trusted financial POS terminals.

Other complimentary existing systems which may be utilized or useful in practicing embodiments of this invention includes: Geo-Fencing—when a consumer with the application installed on their smart phone enters within range of a merchant using this solution the consumers phone would identify the merchant's wireless network and would submit an API call to the cloud-hosted software solution, notifying the system that the consumer is within range; Beacon—when a consumer approaches the check-out counter, they would enter a smaller range of a Bluetooth beacon and again, the smart phone would send an API call to the cloud-hosted software solution notifying the system that the consumer is ready to check-out; Point-of-Sale—when a new sale is initiated, the cash-register would send an API call to the cloud-hosted software solution notifying the system that a sale has been initiated. The software solution identifies which check-out is coordinated with which smart phone; Semi-integrated—the point-of-sale will send a unique identifier and the dollar amount to the cloud-hosted software solution; Push-notification—the cloud-hosted software solution would send a push notification to the smart phone and software application asking the consumer if they approve of the transaction; Wallet—assuming the consumer agrees with the transaction and amount, they are prompted to use their default configured card on file in their software wallet; Tokenization—this card is stored in a tokenized fashion but will submit the sensitive data required for a card-present contactless transaction; Point-to-Point Encryption—the terminal software on the consumers phone will encrypt the tokenized wallet and authorization information and submit it to the cloud-hosted software solution for processing; and/or Quick-chip—EMV allows for the user to authenticate a transaction before the amount is totaled.

Assuming a particular sale utilizing embodiments of this invention were approved, the consumer would receive an electronic notification of a receipt either within the application or via email or text, depending on their configuration preferences. The point-of-sale will simultaneously receive confirmation that the transaction was approved, and the transaction will be completed.

While there seems to be several steps in this process, it is all handled by the computers and takes place quietly in the background in only a fraction of a second. The consumer acknowledgement of the transaction is minimal on the part of the consumer compared to the traditional interaction. The merchant enjoys lower transaction costs, improved security and less difficult regular audits because of the nature of the solution provided by this invention.

It is an object of some embodiments of this invention to provide a consumer digital or software wallet, with a merchant terminal configured to dynamically connect in a remote-integrated fashion with the physical point-of-sale so as to facilitate a contactless consumer authenticated transaction via their personal device. This invention accomplishes this and other objects and has the advantage of allowing certain credit card transactions to be classified as card-present instead of card-not-present.

It is also an object of some embodiments of this invention to provide a more effective way of adding a credit card or card to the user's wallet, which this invention accomplishes as described more fully below.

Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 shows a general system and flow diagram for an embodiment of this invention, illustrating a user and depicts certain potential components which may be utilized in this invention;

FIG. 2 shows a system and flow diagram for an embodiment of this invention, illustrating a user, and depicts certain potential components which may be utilized in this invention in communication with cloud-based system including credit cards and an issuing financial institution such as a bank;

FIG. 3 shows a system and flow diagram for an embodiment of this invention, illustrating a user's potential access or mobile device interacting with a cloud-based verification system which includes communication with an issuing financial institution and a point-of-sale component;

FIG. 4 shows a system and flow diagram for an embodiment of this invention, illustrating a system and method for the addition of a credit card to the user's wallet; and

FIG. 5 shows a system and flow diagram for an embodiment of the invention, illustrating an exemplary system and method for processing a transaction as contemplated by this invention.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

Prior to discussing specific embodiments of the invention, some terms may be described in detail.

A “credential” may be any suitable information that serves as reliable evidence of worth, ownership, identity, or authority. A credential may be a string of numbers, letters, or any other suitable characters, as well as any object or document that can serve as confirmation. Examples of a credential include payment credentials, coupon identifiers, information needed for obtaining a promotional offer, identification cards, certified documents, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc, CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

A “token” may be a substitute value for a credential. A token may be a string of numbers, letters, or any other suitable characters. Example of tokens include payment tokens, access tokens, personal identification tokens, etc.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234,” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other-information which may be replaced with a substitute value (i.e., token). Tokenization may be used to enhance transaction efficiency, improve transaction security, increase service transparency, or to provide a method for third-party enablement.

A “token provider” or “token service system” can include a system that services payment tokens. In some embodiments, a token service system can facilitate requesting, determining (e.g., generating) and/or issuing tokens, as well as maintaining an established mapping of tokens to Primary Account Numbers (PANs) in a repository (e.g. token vault). In some embodiments, the token service system may establish a token assurance level for a given token to indicate the confidence level of the token to PAN binding. The token service system may include or be in communication with a token vault where the generated tokens are stored. The token service system may support token processing of payment transactions submitted using tokens by de-tokenizing the token to obtain the actual PAN. In some embodiments, a token service system may include a token service computer alone, or in combination with other computers such as a transaction processing network computer. Various entities of a tokenization ecosystem may assume the roles of the token service provider. For example, payment networks and issuers or theft agents may become the token service provider by implementing the token services according to embodiments of the present invention. In some embodiments, there may be multiple token service systems associated with a set of payment credentials. For example, a set of payment credentials can be tokenized once by a first token service system, and then that token may be tokenized a second time by a second token service system.

A “token vault” may be an example of a token service computer and can include a repository that maintains established token-to-PAN mappings, According to various embodiments, the token vault may also maintain other attributes of the token requester that may be determined at the time of registration. The attributes may be used by the token service provider to apply domain restrictions or other controls during transaction processing. In some embodiments, the token vault may be a part of the token service system or the token service provider. Alternatively, the token vault may be a remote repository accessible to the token service provider. Token vaults, due to the sensitive nature of the data mappings that are stored and managed in them, may be protected by strong underlying physical and logical security.

“Token exchange” or “de-tokenization” may include a process of restoring the data that was substituted during tokenization. For example, a token exchange may include replacing a payment token with a corresponding primary account number (PAN) that was associated with the payment token during tokenization of the PAN. Thus, the de-tokenization may refer to the process of redeeming a token for the associated PAN value based on a token-to-PAN mapping stored, for example, in a token vault. The ability to retrieve a PAN in exchange for the associated token may be restricted to specifically authorized entities, individuals, applications, or systems. Further, de-tokenization or token exchange may be applied to any other information. In some embodiments, token exchange may be achieved via a transactional message, such as an ISO message, an application programming interface (API), or another type of web interface (e.g., web request). Token exchange may also be achieved via a credential request message, whereby a requesting entity, which may be a token holder, requests to receive a PAN associated with a token.

A “requester” includes an entity that requests payment credentials. The requestor may initiate a request that a payment token be de-tokenized by submitting a “credential request” or a “de-tokenization request” message to the token service provider. In some embodiments, the requestor may possess a payment token associated with a consumer, and the requestor may wish to have access to the payment credentials associated with the payment token. The requestor may wish to use the payment credentials for record keeping, consumer analysis, refunds, or any other suitable purpose. The requestor may be an application, a device, a process, or a system that is configured to perform actions associated with tokens or payment credentials. A requestor may interface with a network token system through any suitable communication networks and/or protocols (e.g., using HTTPS, SOAP and/or an XML Interface among others). Some non-limiting examples of credential requestors (which also may be token requestors) may include, for example, merchants, acquirers, communication devices (e.g., mobile phones and computers) operated by users, acquirer processors, and payment gateways acting on behalf of merchants, payment enablers (e.g., original equipment manufacturers, mobile network operators, etc.), digital wallet providers, issuers, third party wallet providers, and/or transaction processing networks. A requestor may be registered and identified uniquely by the token service provider within the tokenization ecosystem. During requestor registration, the token service provider may formally process the requestors application to participate in the token service system. The token service provider may collect information pertaining to the nature of the requestor and to permissions allowed for the requestor (e.g., which types of tokens can be de-tokenized for the requestor). In some embodiments, a requestor may register with a certificate authority, and the certificate authority may sign and/or issue a tokenization certificate associated with the requestor.

A “credential request” or a “de-tokenization request” may be a message for requesting sensitive information (e.g., payment credentials) associated with a token. A credential request may include a payment token, a tokenization certificate associated with the requestor, and any other suitable information. In some embodiments, a credential request can be formatted similarly to an authorization request message, and may be sent along the same channels as an authorization request message. The credential request may be routed based on the token included in the message. For example, the token may be indicative of the token provider that issued the token, and the credential request may be routed to that token provider.

A “credential response” or a “de-tokenization response” may be a message or an electronic message in reply to credential request message generated by a token provider, such as an issuing financial institution or a transaction processing network. The credential response message may include, by way of example only, a set of de-tokenized payment credentials (e.g., a PAN and/or expiry date), an indication of successful or unsuccessful de-tokenization, and any other suitable information. In some embodiments, the de-tokenized payment credentials may be encrypted (e.g., via the requestor's public key).

A “token domain” may indicate an area and/or circumstance in which a token can be used. Examples of the token domain may include, but are not limited to, payment channels (e.g., e-commerce, physical point-of-sale, etc.), POS entry modes (e.g., contactless, magnetic stripe, etc.), and merchant identifiers to uniquely identify where the token can be used. A set of parameters (i.e. token domain restriction controls) may be established as part of token issuance by the token service provider that may avow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified, Some exemplary token domain restriction controls may require the verification of the presence of a token cryptogram that is unique to a given transaction. In some embodiments, a token domain can be associated with a token requestor.

“Token expiry date” may refer to the expiration date/time of the token. The token expiry date may be passed among the entities of the tokenization ecosystem during transaction processing and/or credential requests to ensure interoperability. The token expiration date may be a numeric value (e.g. a 4-digit numeric value).

An “encryption key” may include any data value or other information suitable to cryptographically encrypt data. A “decryption key” may include any data value or other information suitable to decrypt encrypted data. In some cases, an encryption key and a decryption key may be the same (i.e., a “symmetric key”).

The term “public/private key pair” may include a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. A public key may be authorized by a body known as a Certification Authority (CA) which stores the public key in a database and distributes it to any other entity which requests it. A private key may typically be kept in a secure storage medium and may usually only be known to the entity. However, the cryptographic systems described herein may feature key recovery mechanisms for recovering lost keys and avoiding data loss. Public and private keys may be in any suitable format, including those based on RSA or elliptic curve cryptography (ECC).

A “digital signature” or “signature” may refer to the result of applying an algorithm based on a public/private key pair, which allows a signing party to manifest, and a verifying party to verify, the authenticity and integrity of a document or other information. The signing party acts by means of the private key and the verifying party acts by means of the public key. This process certifies the authenticity of the sender, the integrity of the signed document and the so-called principle of nonrepudiation, which does not avow disowning what has been signed. A certificate or other data that includes a digital signature by a signing party is said to be “signed” by the signing party.

A “certificate” may include an electronic document or data file that uses a digital signature to bind a public key with data associated with an identity. The certificate may include one or more data fields, such as the legal name of the identity, a serial number of the certificate, a valid-from and valid-to date for the certificate, certificate-related permissions, etc. A certificate may contain a “valid-from” date indicating the first date the certificate is valid, and a “valid-to” date indicating the last date the certificate is valid. A certificate may also contain a hash of the data in the certificate including the data fields. Unless otherwise noted, each certificate may be signed by a certificate authority (e.g., if the certificate is a PKI certificate).

A “certificate authority” (CA) may include one or more server computers operatively coupled to issue certificates to entities. The CA may receive an unsigned certificate from an entity, validate the information in the unsigned certificate, sign the certificate, and return the signed certificate to the entity. Alternatively, the CA may generate and sign a certificate for an entity, and then provide the certificate to the entity. The CA may prove its identity using a CA certificate, which includes the CA's public key. The CA certificate may be signed by another CA's private key, or may be signed by the same CA's private key. The latter is known as a self-signed certificate. The CA also typically maintains a database of all certificates issued by the CA.

In a typical process, the certificate authority receives an unsigned certificate from an entity whose identity is known. The unsigned certificate includes a public key, one or more data fields, and a hash of the data in the certificate. The CA signs the certificate with a private key corresponding to the public key included on the CA certificate. The CA may then store the signed certificate in a database, and issue the signed certificate to the entity. Thus, the CA private key may be used to sign the certificate for a first entity, and other entities may be able to use the CA's public key to validate the signature and certificate.

Additionally, the certificate may include a second public key, this public key would be associated with the first entity. Other entities may use this second public key to encrypt messages for secure transmission to the first entity, and the first entity may use a paired private key to decrypt the messages.

A “mobile device” may comprise any suitable electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—i.e. using the other device as a modem—both devices taken together may be considered a single mobile device).

A mobile device may also include any suitable device that may be used to conduct a financial transaction, such as to provide payment credentials to a merchant. Such a mobile device may be in any suitable form. For example, suitable mobile devices can be hand-held and compact so that they can fit into a user's wallet and/or pocket (e.g., pocket-sized). They may include smart cards, magnetic stripe cards, keychain devices (such as the Speedpass™ commercially available from Exxon-Mobil Corp.), etc. Other examples of mobile devices include pagers, payment cards, security cards, access cards, smart media, transponders, and the like. If the mobile device is in the form of a debit, credit, or smartcard, the mobile device may also optionally have features such as magnetic stripes. Such devices can operate in either a contact or contactless mode.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may avow the user to load one or more payment cards onto the digital wallet so as to make a payment without having to enter an account number or present a physical card.

A “digital wallet provider” may include an entity, such as an issuing bank or third-party service provider, that issues a digital wallet or mobile wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or bad financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

A “user” may include an individual that may be associated with one or more personal accounts and/or mobile devices. The user may also be referred to as a cardholder, account holder, or consumer.

A “resource provider” may be an entity that can provide goods, services, information, and/or access. Examples of a resource provider includes merchants, access devices, secure data access points, etc.

A “merchant” may typically be an entity that engages in transactions and can sell goods or services, or provide access to goods or services, An “acquirer” may typically be a business entity (e.g., a commercial bank) that has a business relationship with a particular merchant or other entity. Some entities can perform both issuer and acquirer functions. Some embodiments may encompass such single entity issuer-acquirers.

An “issuer” or “authorizing entity” may typically refer to a business entity (e.g., a bank) that maintains an account for a user.

An “access device” may be any suitable device that provides access to a remote system. An access device may also be used for communicating with a merchant computer, a transaction processing network, an authentication computer, or any other suitable system, An access device may generally be located in any suitable location, such as at the location of a merchant. An access device may be in any suitable form. Some examples of access devices include POS or point-of-sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a FOS terminal, any suitable POS terminal may be used and may include a reader, a processor, and a computer-readable medium. A reader may include any suitable contact or contactless mode of operation. For example, exemplary card readers can include radio frequency (RF antennas, optical scanners, bar code readers, or magnetic stripe readers to interact with a payment device and/or mobile device. In the examples provided herein, an access device and merchant computer may be referred to as separate system components. It should be appreciated, however, that the access device and merchant computer may be a single component, for example, one merchant mobile device or POS device.

An “authorization request message” may be an electronic′, message that is sent to a transaction processing network and/or an issuer of a payment card to request authorization for a transaction.

An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, etc., as well as any other information that may be utilized in determining whether to identify and/or authorize a transaction.

An “authorization response message” may be an electronic message reply to an authorization request message generated by an issuing financial institution or a transaction processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing network) to the merchant's access device (e.g. POS equipment) that indicates approval of the transaction. The code may serve as proof of authorization. As noted above, in some embodiments, a transaction processing network may generate or forward the authorization response message to the merchant.

A “server computer” may include a powerful computer or cluster of computers. For example, the server computer can be a large mainframe, a minicomputer duster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

As mentioned above, it is possible for a credential, such as a PAN, to be tokenized more than once. For example, a first token provider may generate a first token to represent a PAN, and may provide the first token to another entity. The entity that receives the first token may be a second token provider. The second token provider may generate a second token to represent the first token, and then store both the first token and second token. The second token provider may then provide the second token to another entity, which could be a third token provider. The third token provider may generate a third token that represents the second token. This chain of tokens can continue for any suitable number of iterations.

Acronyms that may be used herein may include, without limitation: Payment Card Industry Security Standard Council (PCI-SSC); Payment Application Data Security Standard (PA-DSS); and/or Contactless Payments on Commercial Off The Shelf devices (CPoCOTS).

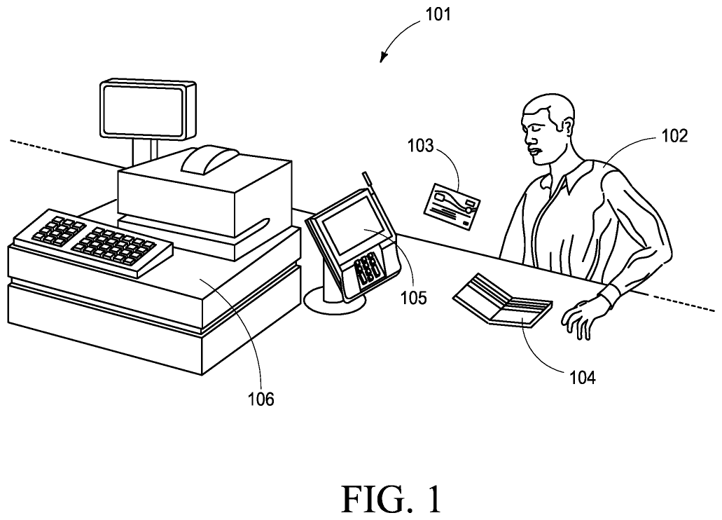

FIG. 1 shows a general system and flow diagram for an embodiment of this invention, illustrating a user and depicts certain potential components which may be utilized in this invention. FIG. 1 illustrates mobile payment system 101, user 102, credit card 103, physical wallet 104, credit card payment device 105 and cash register 106, which are basic potential components of embodiments of this invention.

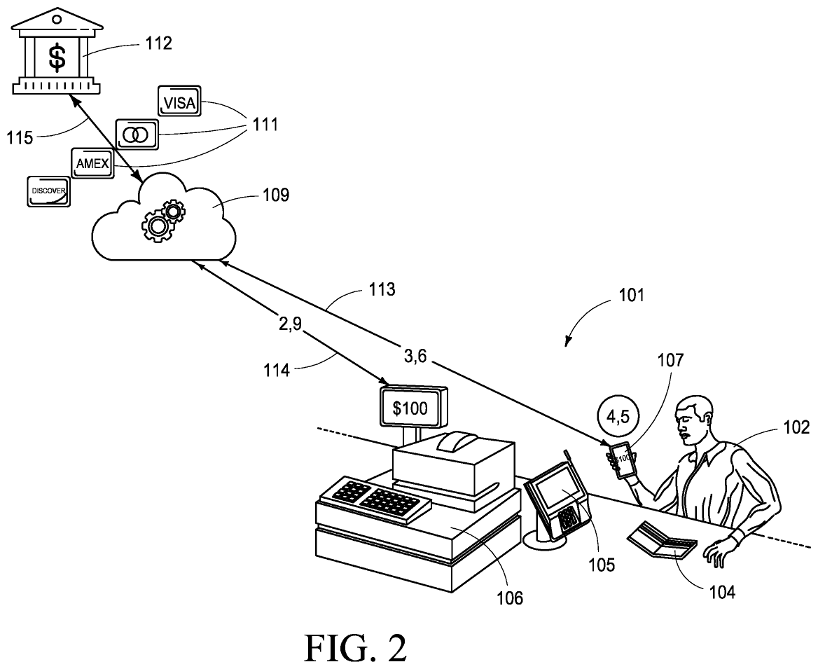

FIG. 2 shows a system and flow diagram for an embodiment of this invention, illustrating a user, and depicts certain potential components which may be utilized in this invention in communication with cloud-hosted software 109 based system including credit cards and an issuing financial institution such as a bank. FIG. 2 illustrates mobile payment system 101, user 102, physical wallet 104, credit card payment device 105, cash register 106, cloud-hosted software 109, multiple potential credit cards 111 that are part of or available to the user, and also representatively shows an issuing financial institution 112. Communication lines 113, 114 and 115 illustrate communication lines or pathways between the various components as described more fully herein.

It will be recognized by those of ordinary skill in the art that when communication lines or pathways are referred to herein, it is intended to potentially refer to all known methods thereof—such as individually or collectively, combinations of lines or pathways, which may include hard wired lines as well.

In FIG. 2, which may be a retail store environment, the cashier brings up the sale and the amount of the sale is then sent to the cloud-hosted system 109 via communication line 114. The transaction is then pushed to the user's 102 smart phone mobile device 107 via communication line 113. The user would then approve the transaction on his or her smart phone access device 107 and a Secure Element (SE) then sends a dynamic Cryptogram, DAN, Dynamic CVV to terminal software within the same application within the smart phone access device 107.

The terminal software then sends the transaction to cloud-hosted solution as a Contactless Payment, and on to the processor via communication pathway or line 113. The processor then sends data to the credit card network and the credit card network then decrypts the token with TSP and sends this decrypted information or data to the financial institution or bank issuer 112, who then validates the funds and returns a response via communication line 115.

In the example in FIG. 2, the communication line represented as line 113 represents a communication line between the user 102's smart phone 107 and the cloud-hosted software 109, and the communication line represented as line 114 represents a communication line between the cash register system that may typically be found at a retail or restaurant outlet and the cloud-hosted software 109.

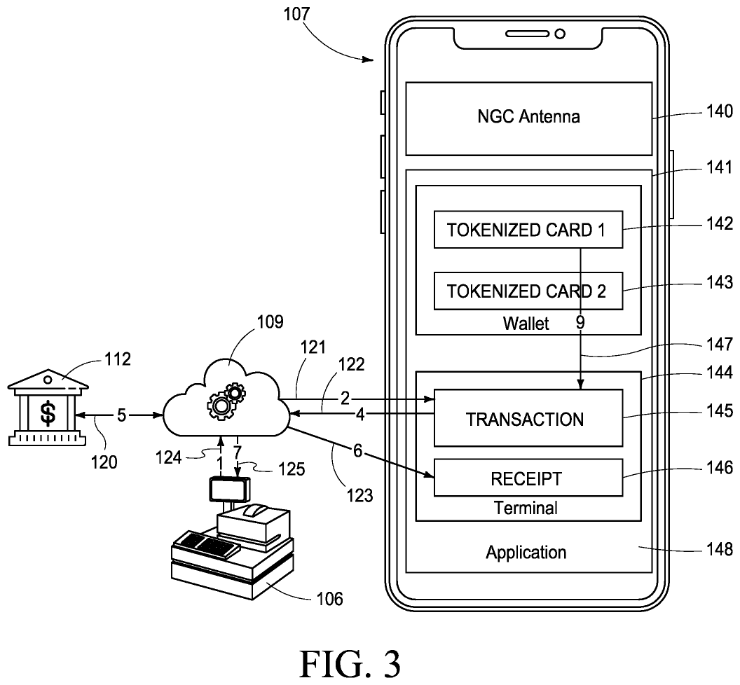

FIG. 3 shows a system and flow diagram for an embodiment of this invention, illustrating a user's potential access or mobile device interacting with a cloud-based verification system which includes communication with an issuing financial institution and a point-of-sale component. FIG. 3 illustrates components or elements such as a smart phone access device 107, cloud-hosted software 109, cash register 106 and issuing financial institution 112. Communication lines 120, 121, 122 and 123 illustrate communication lines or pathways between the various components as described more fully herein.

One example of an embodiment of an application that may be loaded onto a smart phone access device 107 for example is an application which has both wallet and terminal functionality, new and unique combination. Tokenized cards are stored within the wallet and transactions are pushed to the terminal section of the application on the smart phone access device 107. In FIG. 3 the terminal portion is identified as terminal portion 144 and the wallet portion is identified as wallet portion 141. Within wallet portion 141 are first tokenized card 1 142 and second tokenized card 2 143. Within terminal portion 144 are transaction portion 145 and receipt portion 146. Communication line 9 shows the communication line through which transactions may be pushed to the terminal portion 144 or section of the application.

In FIG. 3 the user would prove the use of a Tokenized Card from the Wallet portion 141 to fund a transaction request. The point-of-sale device then initiates the transaction and the final response is to the point-of-sale to device designating that the transaction is complete.

The method or process followed would be the point-of-sale device initiates the transaction as represented by communication line 124 to cloud-hosted software 109. The cloud hosted software 109 system then sends the transaction to the mobile device via communication line 121. The user then approves or disapproves the transaction with the tokenized card, one of which would be the default card on file. At that stage, the transaction is submitted for contactless processing as represented or illustrated by or through communication line 122. It should be noted that the NFC antenna is not accessed at this point.

The transaction is then submitted to the processor and issuing financial institution 112 via communication line 120. The approved transaction and receipt information are then returned to the mobile phone access device 107 through cloud-based software and then via communication line 123. The approved transaction and receipt information are then sent to the point-of-sale device 106.

Smart phone access device 107, which may be something other than a smart phone too, illustrates how various elements of this invention are combined within said smart phone access device 107.

It will be recognized by those of ordinary skill in the art that this unique combination within smart phone access device 107 provides many of the advantages and benefits described elsewhere herein.

FIG. 3 illustrates an access device such as a smart phone, including an NGC Antenna 140, and while an NGC antenna is illustrated in this example of an embodiment, those of ordinary skill in the art will recognize this invention is not so limited but instead may include any one of a number of different types and/or configurations of communication antenna or devices which include the communication functionality.

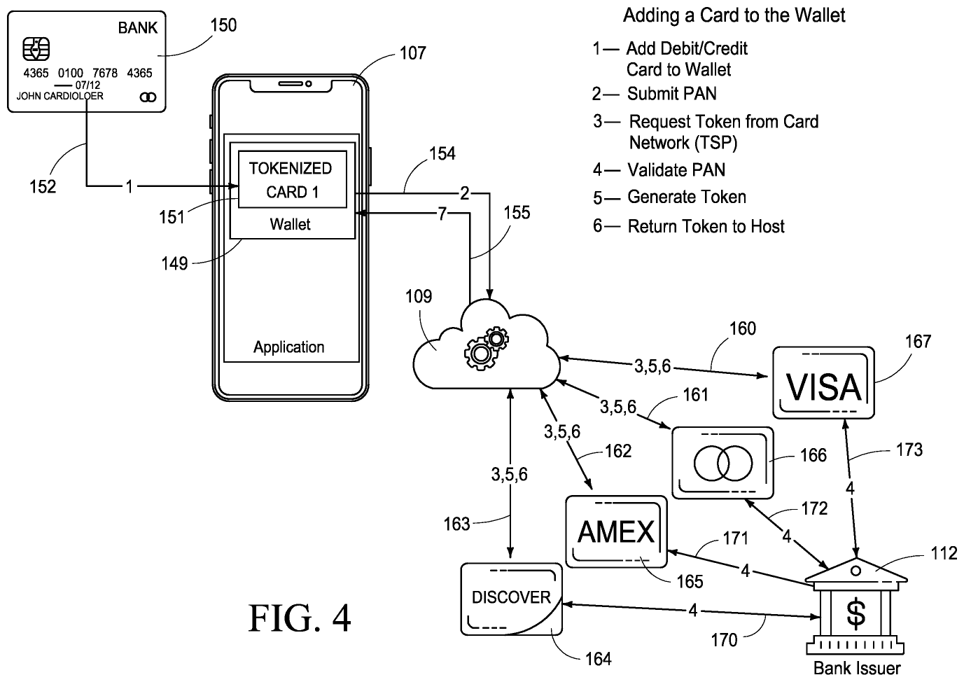

FIG. 4 shows a system and flow diagram for an embodiment of this invention, illustrating a system and method for the addition of a credit card to the user's wallet. FIG. 4 illustrates smart phone access device 107, cloud-hosted software 109 and credit cards 164, 165, 166 and 167, and issuing financial institution 112. Within the depiction of smart phone access device 107 is shown digital or software wallet 149 and first tokenized card 151.

FIG. 4 illustrates one example of an embodiment of an improved and novel way to add a tokenized credit card to the digital or software wallet 149. FIG. 4 illustrates how credit card 150 may be input into the digital or software wallet 149 of the smart phone access device 107, as a tokenized card, in this case a first tokenized card 151. After the data for the credit card 150 is input to be the first tokenized card 151, the information is submitted PAN via communication line 154 to cloud-based software 109. In FIG. 4 different possible examples of credit cards are shown as items 164, 165, 166 and 167. The request token from the cloud-based software 109 is made to the credit card institution from card network TSP within the cloud-based software system. These requests may be made via communication lines 160, 161, 162 and/or 163 respectively.

The next step is to validate PAN with the credit card issuing financial institution, in this case a bank issuer, via communication lines 170, 171, 172 and 173. Once validation occurs a token is generated for said credit card and transmitted by one or more of the respective credit card companies back to the cloud-based software 109 via communication lines 160, 161, 162 and/or 163. Thereafter the token is returned to the smart phone access device 107 to become a stored tokenized card therein.

It will be appreciated and recognized by those of ordinary skill in the art that when the term or reference to communication paths or lines is used, it is to refer to any and all wholly wireless or hardwired arrangements, or combinations of the two, to facilitate the communication of data and signals between the various components or elements of the embodiments of this invention illustrated in the drawings.

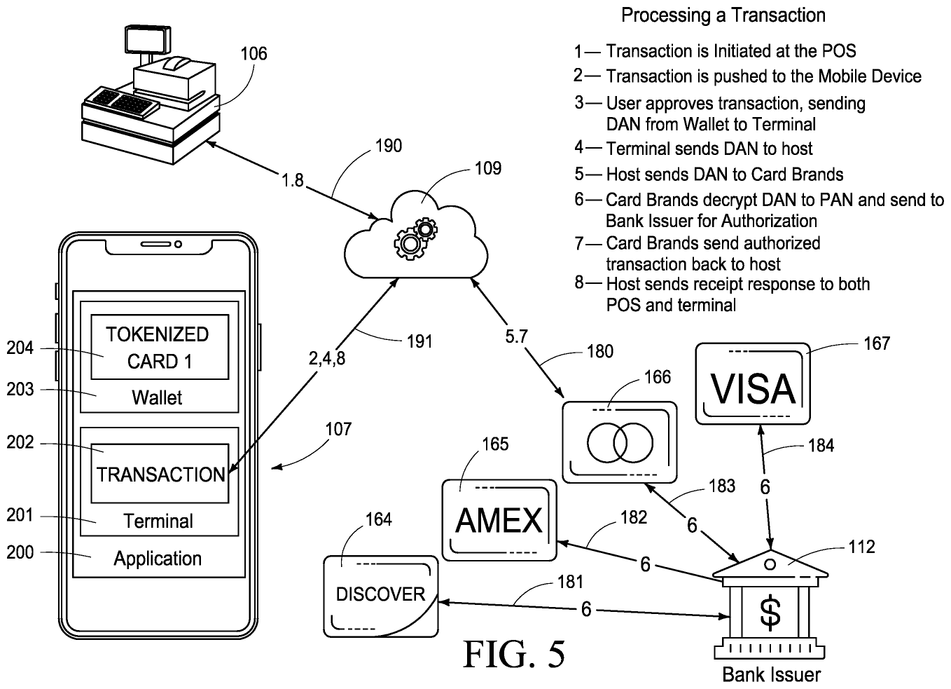

FIG. 5 shows a system and flow diagram for an embodiment of the invention, illustrating an exemplary system and method for processing a transaction as contemplated by this invention. In illustrating this embodiment of the invention which is a system and method for processing a transaction, components or elements cash register 106, cloud-hosted software 109, smart phone access device 107, issuing financial institution 112 and the exemplary credit cards 164, 165, 166 and 167, are shown.

FIG. 5 illustrates one example of an embodiment of this invention may be utilized in processing a transaction. The general process or method would generally occur as set forth below. The transaction would be initiated at the point-of-sale device 106 is sent via communication line 190 through cloud-based software 109 and thereafter pushed from cloud-based software 109 to the smart phone access device or mobile device 107.

Once communicated to the smart phone access device 107 the user would approve the transaction, sending DAN from the wallet portion 203 to the terminal portion 201 within application 200. It will be noted that the wallet portion 203 includes a first tokenized card 204. The terminal portion of the smart phone access device 107 would then send DAN to the host within the cloud-based software 109 via communication line 191. The host within the cloud-based software 109 would then send DAN to PAN and send it to the bank issuer or financial institution for authorization, via communication line 180.

The card brands 164, 165, 166 and 167 would then decrypt DAN to PAN and send the PAN to the issuing financial institution or bank issuer 112 for authorization, via communication lines 181, 182, 183 and 184 respectively. Once the transaction is authorized, the card brands 164, 165, 166 and/or 167 would send the authorized transaction data back to the host within cloud-based software 109 via communication line 180. The cloud-based software host would then send the receipt response to both the point-of-sale device and to the terminal portion of the application within the smart phone access device 107. This would complete or conclude the transaction.

### Exemplary Applications of Some Embodiments of this Invention

While there are numerous applications for aspects of embodiments of this invention, the examples set forth below represent some of the potential applications thereof.

The first example of an embodiment of this invention is a system and method for use in payments in a grocery or other store. In this embodiment, the user or consumer has a smart phone with the mobile application or invention elements installed. The user grants the mobile application access to the user's location, as well as granting the application to its wi-fi and its Bluetooth.

The user or consumer enters the grocery store within access of its Wi-Fi, and the application submits an API call to the cloud-hosted software solution. The user or consumer then shops and selects what to purchase, thereafter approaching the checkout lane. The application of the invention recognizes the presence of a Bluetooth beacon (in this example) and then submits another API call to the cloud-hosted software solution. The store's cash-register begins a new sale transaction and submits an API call to the cloud-hosted software solution.

Next the cloud-hosted software solution sends a push notification to the application asking the user to confirm that the use is actually at the proper grocery store, and intends to use this application to pay for this purchase. In this example the user may pre-approve the upcoming purchase before knowing the full or exact amount of that purchase—and the user then confirms or approves this aspect of the transaction. At that point tokenized card data from the application is configured into a contactless payment for the unspecified amount and then waits further information or data.

The cash-register or point-of-sale device then completes the sale and sends the amount to the cloud-hosted solution via an API call (in this example or embodiment) and the cloud-hosted solutions push the amount to the mobile application or access device. The application then completes the authorization message and sends it back to the cloud-hosted solution, which in turn routes the transaction to the processor for approval. Once approval is received, the cloud-hosted solution responds to the application with the approval and record of the receipt and the cloud-hosted solution responds to the cash-register with the approval and record of the receipt. This completes the sale in a very short amount of time.

A second example of an embodiment of this invention is a system and method for use in payments in a drive-through environment application. In this example, the user or consumer has a smart phone with the mobile application installed and the user has granted the mobile application access to the user's location, granted the application access to the user's wi-fi and granted the application access to its Bluetooth. As the consumer enters the drive-through of a store utilizing this embodiment or example of this invention, the user nears the order station of the drive-through. The application enters range of a Bluetooth beacon which triggers an API call to the cloud-hosted solution.

The cashier then takes the completed order, at the end of which the cash-register initiates an API call to the cloud-hosted solution with the amount of the order. The cloud-hosted solution pushes a notification to the application asking the user to confirm the total for the order, wherein the user confirms the order (with optional tip if appropriate). The tokenized card data from the application is configured into a contactless payment for the designated amount, the application then completes the authorization message and sends it back to the cloud-hosted solution.

The cloud-hosted solution then routes the transaction to the processor for approval and once approved, the cloud-hosted solution responds to the application with the approval and record of the receipt. At that point the cloud-hosted solution responds to the cash-register with the approval and record of the receipt, the sale is complete, and the user received their ordered product such as food at the service window.

A third example of an embodiment of this invention is a system and method for use in payments is in a dine-in restaurant environment. In this example, the user or consumer has an access device such as a smart phone with the mobile application installed. The user has granted the mobile application access to its location and the user has granted the application access to its wi-fi and access to its Bluetooth.

The user or consumer enters the dine-in restaurant utilizing this solution and once at the table, the application enters range of a Bluetooth beacon which triggers an API call to the cloud-hosted solution. The waiter takes the order, and enters it into a point-of-sale station, at the end of which the cash-register initiates an API call to the cloud-hosted solution with the amount of the order and table number.

The cloud-hosted solution pushes a notification to the application asking the user to confirm the total for the order, which the user then confirms (with an optional tip). The tokenized card data from the application is then configured into a contactless payment for the designated amount, and the application completes the authorization message and sends it back to the cloud-hosted solution. The cloud-hosted solution routes the transaction to the processor for approval and, once approved, the cloud-hosted solution responds to the application with the approval and record of the receipt. The cloud-hosted solution then responds to the cash-register with the approval and record of the receipt, which notifies or shows the server that the table has paid. At that point the sale is complete, the user is served their food.

It will be appreciated by those of ordinary skill in the art that one or more parts or aspects of this invention may be rearranged such that the transaction or sale may be finalized after the food has been served and the user is done with the meal.

A fourth example of an embodiment of this invention is a system and method for use in an e-commerce application or environment. In that case the user or consumer has an access device such as a smart phone with the mobile application installed. The user has granted the mobile application access to its location and the user has further granted the application access to its wi-fi and access to its Bluetooth.

The user consumer then uses an internet browser of his or her choosing to shop online from a merchant utilizing this solution and comes to a point at which the user wishes to complete the order. At the completion of the order, the merchant's software notifies the cloud-hosted solution that this consumer has chosen to pay via this option. The cloud-hosted solution then pushes a notification to the application asking the user to confirm the total for the ecommerce order, which the user confirms.

The tokenized card data from the application is configured into a contactless payment for the designated amount, and the application then completes the authorization message and sends it back to the cloud-hosted solution. The cloud-hosted solution routes the transaction to the processor for approval, and once (and if) so approved, the cloud-hosted solution responds to the application by sending the approval and record of the receipt thereto. The cloud-hosted solution responds to the merchant's ecommerce software with the approval and record of the receipt and the sale is then complete and the merchant may then initiate the shipment of the order.

A fifth example of an embodiment of this invention is a system and method for recurring transactions. In this example or embodiment, the user or consumer has an access device such as a smart phone with the mobile application installed. The user has granted the mobile application access to its location and the user further grants the application access to its wi-fi and access to its Bluetooth.

In this example the consumer does not trigger this transaction, but instead the merchant software recognizes that a recurring scheduled transaction is due. At that point the merchant's software sends an API call to the cloud-hosted solution. The cloud-hosted solution pushes a notification to the application asking the user to confirm the total for the order, which if appropriate, the user so confirms.

The tokenized card data from the application is configured into a contactless payment for the designated amount and the application completes the authorization message and sends it back to the cloud-hosted solution. The cloud-hosted solution routes the transaction to the processor for approval and, once approved, the cloud-hosted solution responds to the application with the approval and record of the receipt. The cloud-hosted solution responds to the merchant's software with the approval and with a record of the receipt, and at that point the sale is complete and the recurring service is maintained without interruption.

As will be appreciated by those of reasonable skill in the art, there are numerous embodiments to this invention, and variations of elements and components which may be used, all within the scope of this invention. In one embodiment for example a mobile payment system is provided which comprises: a virtual terminal configured to receive transaction information remotely from a merchant; a digital wallet configured for use by a user and including at least one payment method therein, the digital wallet configured to generate an approval of a user transaction with the merchant and transmission of said approval is to the virtual terminal.

In addition to the embodiment disclosed in the preceding paragraph, the invention may further include the mobile payment system: further wherein the use of the combination of the digital wallet portion and the merchant terminal portion interacting with the vendor system, cause resulting transactions to be classified as card-present transactions; and further wherein a compliant payment method(s) is stored as designated by an EMV Co Payment Tokenization Framework so as said application can submit a transaction with a Token Domain Restriction Controls that includes the presence and verification of a Token Cryptogram that is unique to each transaction; further wherein the user, in approving this transaction via a remotely integrated commercial off the shelf device, takes full responsibility for said transaction and thereby waives certain dispute rights typically afforded users under card-brand networks rules and regulations; further wherein the transmission of said approval to the virtual terminal is through a merchant point of sale device; and/or further wherein the digital wallet is on a digital mobile device such as a mobile phone or mobile tablet, and the transmit of said approval to the virtual terminal is communicated from the mobile phone or the mobile tablet.

In another embodiment, a mobile payment system for users is provided which converts the classification of certain card-not-present credit transactions to card-present transactions, comprising: a combined user digital wallet and a merchant terminal configured to dynamically connect in a remote-integrated fashion with the physical point-of-sale so as to facilitate a contactless consumer authenticated transaction via the user's access device.

In addition to the embodiment disclosed in the preceding paragraph, the invention may be: further wherein the user digital wallet and the merchant terminal are an integral software combination; and/or further wherein the use of the combination of the digital wallet portion and the merchant terminal portion interacting with the vendor system, cause resulting transactions to be classified as card-present transactions.

In another embodiment, a method of making a mobile digital payment system is provided which converts the classification of certain card-not-present credit transactions to card-present transactions, comprising the following steps: providing a combined user digital wallet and a merchant terminal in a user mobile device, configured to dynamically connect with the physical point-of-sale so as to facilitate a contactless consumer authenticated transaction via the user's personal access device; providing a virtual terminal configured to receive transaction information remotely from a merchant; providing a digital wallet configured for use by a user and including at least one payment method therein, the digital wallet configured to generate an approval of a user transaction with the merchant and transmit said approval to the virtual terminal; and generating a user approval of a transaction with the merchant and transmitting said approval to the virtual terminal. A further embodiment of this method may be further wherein the user digital wallet and the merchant terminal are an integral software combination.

In another embodiment, a mobile application is provided which is comprised of: a digital wallet and virtual terminal, wherein the merchant can remotely send transactions to the terminal and the user can control the process to approve of the transaction with a payment method stored in the user's wallet. This embodiment may be further: comprising compliant payment method(s) stored as designated by the EMV Co Payment Tokenization Framework so as said application can submit a transaction with a Token Domain Restriction Controls that include the presence and verification of a Token Cryptogram that is unique to each transaction; and/or further comprising the consumer in approving this transaction via a remotely integrated commercial off the shelf device (such as a smart phone or tablet) is taking full responsibility for that transaction and waiving certain dispute rights afforded them normally by the card-brand networks rules and regulations.

In yet another embodiment of the invention, a method of inputting credit cards into a digital wallet is provided, which is comprised of the following steps: inputting a credit card data set into digital wallet in an access device; submitting a Primary Account Number (PAN) to cloud-based software, which requests token from card network via a Tokenization Service Provider (TSP); obtaining validation PAN from financial institution issuing the credit card; and sending generated token obtained from credit card company to cloud-based host.

In still another embodiment, a mobile access device is provided which includes software comprised of a digital wallet portion configured to store tokenized credit card information; and a merchant terminal portion comprised of transaction completion processing and transaction receipt processing. This embodiment may, without limitation, be wherein the digital wallet portion and further wherein the use of the combination of the digital wallet portion and the merchant terminal portion interacting with the vendor system, cause resulting transactions to be classified as card-present transactions.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A mobile payment system comprising:
a virtual terminal configured to receive transaction information remotely from a merchant;
a digital wallet configured for use by a user and including at least one payment method therein, the digital wallet configured to generate an approval of a user transaction with the merchant and transmission of said approval is to the virtual terminal.

2. The mobile payment system as recited in claim 1, and further wherein the use of the combination of the digital wallet portion and the merchant terminal portion interacting with the vendor system, cause resulting transactions to be classified as card-present transactions.

3. The mobile payment system recited in claim 1, and further wherein a compliant payment method(s) is stored as designated by an EMV Co Payment Tokenization Framework so as said application can submit a transaction with a Token Domain Restriction Controls that includes the presence and verification of a Token Cryptogram that is unique to each transaction.

4. The mobile payment system recited in claim 1, and further wherein the user, in approving this transaction via a remotely integrated commercial off the shelf device, takes full responsibility for said transaction and thereby waives certain dispute rights typically afforded users under card-brand networks rules and regulations.

5. The mobile payment system recited in claim 1, and further wherein the transmission of said approval to the virtual terminal is through a merchant point of sale device.

6. The mobile payment system recited in claim 1, and further wherein the digital wallet is on a digital mobile device such as a mobile phone or mobile tablet, and the transmit of said approval to the virtual terminal is communicated from the mobile phone or the mobile tablet.

7. A mobile payment system for users which converts the classification of certain card-not-present credit transactions to card-present transactions, comprising: a combined user digital wallet and a merchant terminal configured to dynamically connect in a remote-integrated fashion with the physical point-of-sale so as to facilitate a contactless consumer authenticated transaction via the user's access device.

8. The mobile payment system recited in claim 7, and further wherein the user digital wallet and the merchant terminal are an integral software combination.

9. The mobile payment system as recited in claim 7, and further wherein the use of the combination of the digital wallet portion and the merchant terminal portion interacting with the vendor system, cause resulting transactions to be classified as card-present transactions.

10. A method of making a mobile digital payment system which converts the classification of certain card-not-present credit transactions to card-present transactions, comprising the following steps:
providing a combined user digital wallet and a merchant terminal in a user mobile device, configured to dynamically connect with the physical point-of-sale so as to facilitate a contactless consumer authenticated transaction via the user's personal access device;
providing a virtual terminal configured to receive transaction information remotely from a merchant;
providing a digital wallet configured for use by a user and including at least one payment method therein, the digital wallet configured to generate an approval of a user transaction with the merchant and transmit said approval to the virtual terminal; and
generating a user approval of a transaction with the merchant and transmitting said approval to the virtual terminal.

11. The mobile application as recited in claim 10 and further wherein the user digital wallet and the merchant terminal are an integral software combination.

12. A mobile application comprising: a digital wallet and virtual terminal, wherein the merchant can remotely send transactions to the terminal and the user can control the process to approve of the transaction with a payment method stored in the user's wallet.

13. The mobile application recited in claim 12 and further comprising compliant payment method(s) stored as designated by the EMV Co Payment Tokenization Framework so as said application can submit a transaction with a Token Domain Restriction Controls that include the presence and verification of a Token Cryptogram that is unique to each transaction.

14. The mobile application recited in claim 12 and further comprising the consumer in approving this transaction via a remotely integrated commercial off the shelf device (such as a smart phone or tablet) is taking full responsibility for that transaction and waiving certain dispute rights afforded them normally by the card-brand networks rules and regulations.

15. A method of inputting credit cards into a digital wallet, comprising the following steps:
inputting a credit card data set into digital wallet in an access device;
submitting a Primary Account Number (PAN) to cloud-based software, which requests token from card network via a Tokenization Service Provider (TSP);
obtaining validation PAN from financial institution issuing the credit card; and
sending generated token obtained from credit card company to cloud-based host.

16. A mobile access device which includes software comprised of a digital wallet portion configured to store tokenized credit card information; and a merchant terminal portion comprised of transaction completion processing and transaction receipt processing.

17. The mobile access device recited in claim 16, and further wherein the digital wallet portion and further wherein the use of the combination of the digital wallet portion and the merchant terminal portion interacting with the vendor system, cause resulting transactions to be classified as card-present transactions.
